(19) United States
(12) Patent Application Publication
(10) Pub. No.: US 2015/0189233 A1
(43) Pub. Date: Jul. 2, 2015

(54) FACILITATING USER INTERACTION IN A VIDEO CONFERENCE

(71) Applicants: Thor Carpenter, Snoqualmie, WA (US); Janahan Vivekanandan, Los Altos, CA (US); Frank Petterson, Redwood City, CA (US)

(72) Inventors: Thor Carpenter, Snoqualmie, WA (US); Janahan Vivekanandan, Los Altos, CA (US); Frank Petterson, Redwood City, CA (US)

(73) Assignee: GOGGLE INC., Mountain View, CA (US)

(21) Appl. No.: 13/460,804

(22) Filed: Apr. 30, 2012

(51) Int. Cl. H04N 7/15; G06K 9/00

(52) U.S. Cl. CPC H04N 7/15; G06K 9/00228

(57) ABSTRACT

Embodiments generally relate to facilitating user interaction during a video conference. In one embodiment, a method includes detecting one or more faces of people in a video during a video conference. The method also includes recognizing the one or more faces. The method also includes labeling the one or more faces in the video.

### TECHNICAL FIELD

Embodiments relate generally to video conferencing, and more particularly to facilitating user interaction during a video conference.

### BACKGROUND

Video conferencing is often used in business settings and enables participants to share content with each other in real-time across geographically dispersed locations. A communication device at each location typically uses a video camera and microphone to send video and audio streams, and uses a video monitor and speaker to play received video and audio streams. The communication devices maintain a data linkage via a network and transmit video and audio streams in real-time across the network from one location to another.

### SUMMARY

Embodiments generally relate to facilitating user interaction during a video conference. In one embodiment, a method includes detecting one or more faces of people in a video during a video conference; recognizing the one or more faces; and labeling the one or more faces in the video.

With further regard to the method, the recognizing includes matching each face to samples of faces that have already been recognized and labeled prior to the video conference. In one embodiment, the recognizing includes matching each face to samples of faces that have already been recognized and labeled prior to the video conference, and where at least a portion of the samples of faces has been provided and labeled by users prior to the video conference. In one embodiment, the recognizing includes matching each face to samples of faces that have already been recognized and labeled prior to the video conference, and where at least a portion of the samples of faces has been recognized and labeled during previous video conferences. In one embodiment, the recognizing includes: determining if each face corresponds to a video stream from a single person; and in response to each positive determination, determining the name of each person, where the name of each person is determined from a video conference joining process.

The method further includes training a classifier to recognize faces, where the training of the classifier includes collecting samples of faces that have already been recognized and labeled prior to the video conference. In one embodiment, the training of the classifier includes collecting samples of faces that have already been recognized and labeled prior to the video conference, where at least a portion of the samples of faces has been provided and labeled by users prior to the video conference. In one embodiment, the training of the classifier includes collecting samples of faces that have already been recognized and labeled prior to the video conference, where at least a portion of the samples of faces has been recognized and labeled during previous video conferences. In one embodiment, the training of the classifier includes collecting samples of faces that have already been recognized and labeled prior to the video conference, where at least a portion of the collected samples includes a plurality of samples of faces associated with one person, and where the plurality of samples of faces includes variations of a same face. In one embodiment, the method further includes determining names of some people in the video using a calendaring system, where the calendaring system stores names of participants when video conferences are scheduled.

In another embodiment, a method includes detecting one or more faces of people in a video during a video conference, and recognizing the one or more faces. In one embodiment, the recognizing includes matching each face to samples of faces that have already been recognized and labeled prior to the video conference, where at least a portion of the samples of faces has been provided and labeled by users prior to the video conference; determining names of some people in the video using a calendaring system, where the calendaring system stores names of participants when video conferences are scheduled; and determining if each face corresponds to a video stream from a single person. In one embodiment, in response to each positive determination, the method includes determining the name of each person, where the name of each person is determined from a video conference joining process, and labeling the one or more faces in the video.

In another embodiment, a system includes one or more processors, and logic encoded in one or more tangible media for execution by the one or more processors. When executed, the logic is operable to perform operations including: detecting one or more faces of people in a video during a video conference; recognizing the one or more faces; and labeling the one or more faces in the video.

With further regard to the system, to recognize the one or more faces, the logic when executed is further operable to perform operations including matching each face to samples of faces that have already been recognized and labeled prior to the video conference. In one embodiment, to recognize the one or more faces, the logic when executed is further operable to perform operations including matching each face to samples of faces that have already been recognized and labeled prior to the video conference, where at least a portion of the samples of faces has been provided and labeled by users prior to the video conference. In one embodiment, to recognize the one or more faces, the logic when executed is further operable to perform operations including matching each face to samples of faces that have already been recognized and labeled prior to the video conference, where at least a portion of the samples of faces has been recognized and labeled during previous video conferences. In one embodiment, to recognize the one or more faces, the logic when executed is further operable to perform operations including: determining if each face corresponds to a video stream from a single person; and in response to each positive determination, determining the name of each person, where the name of each person is determined from a video conference joining process.

With further regard to the system, the logic when executed is further operable to perform operations including training a classifier to recognize faces, and where the training of the classifier includes collecting samples of faces that have already been recognized and labeled prior to the video conference. In one embodiment, the logic when executed is further operable to perform operations including training a classifier to recognize faces, where the training of the classifier includes collecting samples of faces that have already been recognized and labeled prior to the video conference, and where at least a portion of the samples of faces has been provided and labeled by users prior to the video conference. In one embodiment, the logic when executed is further operable to perform operations including training a classifier to recognize faces, where the training of the classifier includes collecting samples of faces that have already been recognized and labeled prior to the video conference, and where at least a portion of the samples of faces has been recognized and labeled during previous video conferences. In one embodiment, the logic when executed is further operable to perform operations including training a classifier to recognize faces, where the training of the classifier includes collecting samples of faces that have already been recognized and labeled prior to the video conference, where at least a portion of the collected samples includes a plurality of samples of faces associated with one person, and where the plurality of samples of faces includes variations of a same face.

### BRIEF DESCRIPTION OF THE DRAWINGS

FIG. 1 illustrates a block diagram of an example network environment, which may be used to implement the embodiments described herein.

FIG. 2 illustrates an example simplified flow diagram for facilitating user interaction during a video conference.

FIG. 3 illustrates an example simplified graphical user interface, according to one embodiment.

FIG. 4 illustrates a block diagram of an example server device, which may be used to implement the embodiments described herein.

### DETAILED DESCRIPTION

Embodiments described herein provide a method for adding labels to a video of a video conference. In one embodiment, a system obtains the video during the video conference, detects one or more faces of people in the video, and then recognizes the faces. In one embodiment, to recognize the faces, the system identifies each face in the video and then matches each face to sample images of faces that have already been recognized and labeled prior to the video conference. In some scenarios, a portion of the samples may be provided and labeled by users prior to the video conference. For example, during a classifier training process, the system may enable users to provide profile images with tags to the system. In some scenarios, a portion of the samples may be recognized and labeled during previous video conferences.

In another embodiment, to recognize the faces, the system detects each face in a video stream and then determines if each face corresponds to a video stream from a single person. In response to each positive determination, the system may determine the name of each person, where each name is ascertained from a video conference joining process. For example, each person may provide his or her name when joining the conference. Hence, if a given video stream shows a single person, the name of that person would be known. The system may also ascertain the name of each person using a calendaring system, where the calendaring system stores names of participants when video conferences are scheduled. The system then labels the one or more faces in the video based in part on the list of participants.

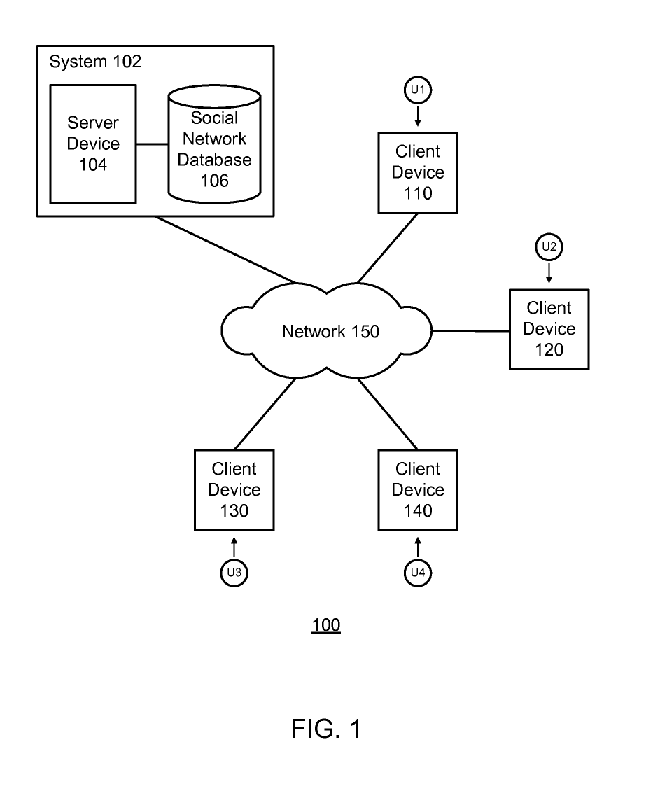

FIG. 1 illustrates a block diagram of an example network environment 100, which may be used to implement the embodiments described herein. In one embodiment, network environment 100 includes a system 102, which includes a server device 104 and a social network database 106. The term “system 102” and the phrase “social network system” may be used interchangeably. Network environment 100 also includes client devices 110, 120, 130, and 140, which may communicate with each other via system 102 and a network 150.

For ease of illustration, FIG. 1 shows one block for each of system 102, server device 104, and social network database 106, and shows four blocks for client devices 110, 120, 130, and 140. Blocks 102, 104, and 106 may represent multiple systems, server devices, and social network databases. Also, there may be any number of client devices. In other embodiments, network environment 100 may not have all of the components shown and/or may have other elements including other types of elements instead of, or in addition to, those shown herein.

In various embodiments, users U1, U2, U3, and U4 may communicate with each other using respective client devices 110, 120, 130, and 140. For example, users U1, U2, U3, and U4 may interact with each other in a multi-user video conference, where respective client devices 110, 120, 130, and 140 transmit media streams to each other. In various embodiments, the media stream may include video streams and audio streams. In the various embodiments described herein, the terms users, people, and participants may be used interchangeably in the context of a video conference.

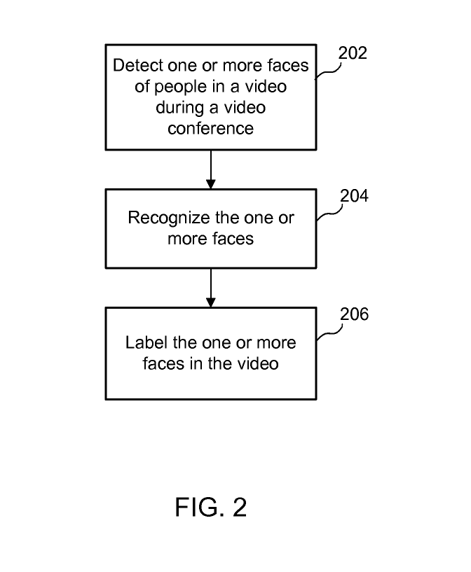

FIG. 2 illustrates an example simplified flow diagram for facilitating user interaction during a video conference. Referring to both FIGS. 1 and 2, a method is initiated in block 202, where system 102 detects one or more faces of people in a video during a video conference.

In one embodiment, during a video conference, system 102 processes each frame in the video stream to detect and track faces (i.e., images of faces) that are present. In one embodiment, system 102 may continuously detect and track faces. In alternative embodiments, system 102 may periodically detect and track faces (e.g., every 1 or more seconds). Note that the term “face” and the phrase “image of the face” are used interchangeably. In one embodiment, system 102 identifies each face in a give video stream, where each face is represented by facial images in a series of still frames in the video stream.

In one embodiment, system 102 may determine that two or more people are sharing a camera. As such, system 102 may identify each face of the two or more people in the video stream. Note that the term “video” and the phrase “video stream” are used interchangeably.

In block 204, system 102 recognizes the one or more faces. In various embodiments, system 102 may employ various algorithms to recognize faces. Such facial recognition algorithms may be integral to system 102. System 102 may also access facial recognition algorithms provided by software that is external to system 102 and that system 102 accesses. In one embodiment, system 102 may compare each face identified in a video stream to samples of faces in reference images in a database, such as social network database 106 or any other suitable database.

In various embodiments, system 102 enables users of the social network system to opt-in or opt-out of system 102 using their faces in photos or using their identity information in recognizing people identified in photos. For example, system 102 may provide users with multiple opt-in and/or opt-out selections. Different opt-in or opt-out selections could be associated with various aspects of facial recognition. For example, opt-in or opt-out selections be associated with individual photos, all photos, individual photo albums, all photo albums, etc. The selections may be implemented in variety of ways. For example, system 102 may cause buttons or check boxes to be displayed next to various selections. In one embodiment, system 102 enables users of the social network to opt-in or opt-out of system 102 using their photos for facial recognition in general.

In various embodiments that facilitate in facial recognition, system 102 may utilize a classifier to match each face identified in a video stream to samples of faces stored in system 102, where system 102 has already recognized and labeled, or “tagged,” the samples of faces prior to the video conference.

In one embodiment, system 102 recognizes faces using stored samples of faces that are already associated with known users of the social network system. Such samples may have been already classified during the training of the classifier prior to the current video conference. For example, some samples may have been provided and labeled by users prior to the video conference.

In various embodiments, system 102 obtains reference images with sample of faces of users of the social network system, where each reference image includes an image of a face that is associated with a known user. The user is known, in that system 102 has the user's identity information such as the user's name and other profile information. In one embodiment, a reference image may be, for example, a profile image that the user has uploaded. In one embodiment, a reference image may be based on a composite of a group of reference images.

As indicated above, system 102 enables users of the social network system to opt-in or opt-out of system 102 using their faces in photos or using their identity information in recognizing people identified in photos.

In one embodiment, to recognize a face in a video stream, system 102 may compare the face (i.e., image of the face) and match the face to sample images of users of the social network system. In one embodiment, system 102 may search reference images in order to identify any one or more sample faces that are similar to the face in the video stream.

For ease of illustration, the recognition of one face in a video stream is described in some of the example embodiments described herein. These embodiments may also apply to each face of multiple faces in a video stream to be recognized.

In one embodiment, for a given reference image, system 102 may extract features from the image of the face in a video stream for analysis, and then compare those features to those of one or more reference images. For example, system 102 may analyze the relative position, size, and/or shape of facial features such as eyes, nose, cheekbones, mouth, jaw, etc. In one embodiment, system 102 may use data gathered from the analysis to match the face in the video stream to one or more reference images with matching or similar features. In one embodiment, system 102 may normalize multiple reference images, and compress face data from those images into a composite representation having information (e.g., facial feature data), and then compare the face in the video stream to the composite representation for facial recognition.

In some scenarios, the face in the video stream may be similar to multiple reference images associated with the same user. As such, there would be a high probability that the person associated with the face in the video stream is the same person associated with the reference images.

In some scenarios, the face in the video stream may be similar to multiple reference images associated with different users. As such, there would be a moderately high yet decreased probability that the person in the video stream matches any given person associated with the reference images. To handle such a situation, system 102 may use various types facial recognition algorithms to narrow the possibilities, ideally down to one best candidate.

For example, in one embodiment, to facilitate in facial recognition, system 102 may use geometric facial recognition algorithms, which are based on feature discrimination. System 102 may also use photometric algorithms, which are based on a statistical approach that distills a facial feature into values for comparison. A combination of the geometric and photometric approaches could also be used when comparing the face in the video stream to one or more references.

Other facial recognition algorithms may be used. For example, system 102 may use facial recognition algorithms that use one or more of principal component analysis, linear discriminate analysis, elastic bunch graph matching, hidden Markov models, and dynamic link matching. It will be appreciated that system 102 may use other known or later developed facial recognition algorithms, techniques, and/or systems.

In some embodiments, some samples may have been recognized and labeled during previous video conferences. For example, each time system 102 successfully recognizes a given user during one or more video conferences, system 102 stores samples of the user's face with an associated label in a database. Accordingly, system 102 accumulates samples of faces of the same user to correlate with new samples of faces from the same user (e.g., from a new/current video conference). This provides a higher degree of certainty that a given face in a video stream is labeled with the correct user.

In one embodiment, system 102 may determine if each face corresponds to a video stream from a single person. In one embodiment, in response to each positive determination of a face corresponding to a respective video stream from a single person, system 102 may determine the name of each person, where the name of each person is determined from a video conference joining process.

In one embodiment, system 102 may determine the names of some or all participants in the video conference using a calendaring system. For example, in one embodiment, when a user schedules the video conference, the user may enter the names of the participants. System 102 may then store a list of the names of all attendees who are scheduled to participate in the video conference.

In various embodiments, when the actual video conference begins, each participant may sign in to the video conference as each participant joins the video conference. System 102 may then compare the name of each participant who joins the video conference with the names listed in the stored list of participants scheduled to attend the video conference. In one embodiment, system 102 may verify the identity of each participant using facial recognition. In one embodiment, system 102 may display the invite list to the participants, and each participant may verify that each is indeed present for the video conference. The probability of matches would be high, because the participants are scheduled to attend the video conference. In various embodiments, the calendaring system may be an integral part of system 102. In another embodiment, the calendaring system may be separate from system 102 and accessed by system 102.

System 102 continues the process with a predetermined frequency (e.g., every 2, 3, or more seconds) as long as there is a face that has not been recognized. If a new face enters a video stream (e.g., participant joins the video conference), or a face leaves a video stream and re-enters, system 102 resume the recognition process.

Referring still to FIG. 2, in block 206, system 102 labels the one or more faces in the video. For example, in one embodiment, system 102 may associated a face tag with each of the recognized faces. In one embodiment, for each recognized face, system 102 causes a virtual “name tag” or other identifier to be displayed near the recognized face on the video stream during rendering. In various embodiments, system 102 enables users of the social network system to opt-in or opt-out of system 102 displaying identifiers next to their faces in video streams.

Accordingly, participants in the video conference will know who is who from the displayed identifiers. This is especially useful in scenarios where multiple people share a camera during a video conference, which could be unclear to other users to know who is who.

In one embodiment, system 102 enables users to manually relabel faces in the event of a recognition false positive. For example, if a face is recognized as Tom but the actual person is Bob, system 102 would enable any user to change the identifier of the face from “Tom” to “Bob.”

In one embodiment, if system 102 is unable to recognize a face after a predetermined number of attempts (e.g., 2 or 3 or more attempts), system 102 may prompt the user(s) to manually label the face. System 102 may then use the manual recognition of a user's face for the duration of the video conference. Once labeled, system 102 includes the labeled face in the training process, as described above.

As indicated above, in various embodiments, system 102 may utilize a classifier to match each face identified in a video stream to samples of faces stored in system 102. The classifier facilitates in facial recognition by utilizing sample image of faces that system 102 has already recognized and labeled prior to a video conference. In one embodiment, the classifier may be an integral portion of system 102. In another embodiment, the classifier may be separate from system 102 and accessed by system 102.

In various embodiments, system 102 may collect numerous samples of faces for each user of the social network system for training the classifier. System 102 may then utilize the samples for facial recognition during multiple future video conferences.

These samples may be provided manually via an offline process. For example, in one embodiment, users may select faces in their online photo albums and label them appropriately. Alternatively, or in conjunction with the manual process, system 102 may collect samples automatically when a logged-in user is in a video conference and there is only one face in view of that user's camera. System 102 may then process each frame in the video stream to detect and track that face, and system 102 randomly chooses face samples for inclusion in a facial recognition training routine for the logged-in user. In one embodiment, system 102 may bias the random selection towards faces that are detected with higher confidence. In one embodiment, system 102 may, during an offline process, run the facial recognition training routine and update the database of faces for future recognition tasks.

In various embodiments, system 102 continually collects training samples, but at a reduced frequency over time. Over time, system 102 may accumulate various samples of the same face for a given user, where different samples may have different characteristics, yet still be recognizable as the face of the same person. For example, in various embodiments, system 102 recognizes faces based on key facial characteristics such as eye color, distance between eyes, cheekbones, nose, facial color, etc.

System 102 is able to handle variations in images of faces by identifying and matching key facial characteristics of a face identified in a video stream with key facial characteristics in different samples. For instance, there may be samples where a given user is wearing eye glasses, and samples where the same user is not wearing glasses. In another example, there may be samples showing the same user with different hair lengths. In another example, there may be samples showing the same user with and without a hat. Furthermore, system 102 may collect samples taken under various lighting conditions (e.g., low lighting, medium lighting, bright lighting, etc.). Such samples with variations of the same face enable system 102 to recognize faces with more accuracy.

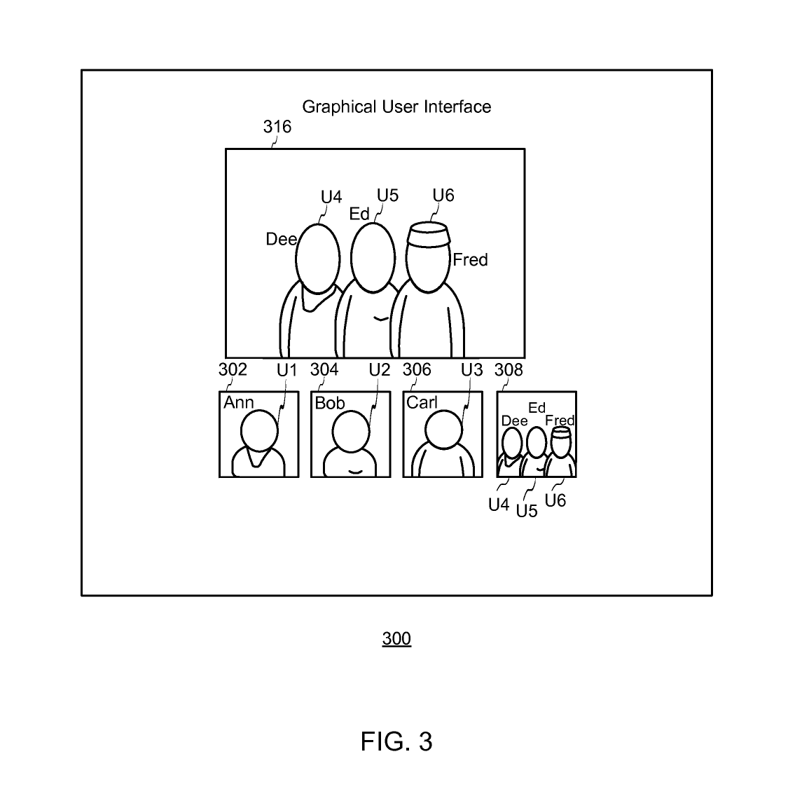

FIG. 3 illustrates an example simplified graphical user interface (GUI) 300, according to one embodiment. In one embodiment, GUI 300 includes video windows 302, 304, 306, and 308, which display video streams of respective users U1, U2, U3, U4, U5, and U6 who are participating in the video conference. For ease of illustration, six users U1, U2, U3, U4, U5, and U6 are shown. In various implementations, there may be various numbers of users participating in a video conference.

In one embodiment, GUI 300 includes a main video window 316, which displays a video stream of the user who is currently speaking. As shown in FIG. 3, in this particular example, main video window 316 is displaying a video stream of users U4, U5, and U6, where one of the users U4, U5, and U6 is currently speaking. In one embodiment, main video window 316 is a larger version of the corresponding video window (e.g., video window 308). In one embodiment, main video window 316 may be larger than the other video windows 302, 304, 306, and 308, and may be centralized in the GUI to visually indicate that the user or users shown in main video window 316 are speaking. In one embodiment, the video stream displayed in main video window 316 switches to a different video stream associated with another end-user each time a different user speaks.

As shown in this example embodiment, a label is displayed next to each person in the different video windows 316, 302, 304, 306, and 308. For example, user U1 is labeled “Ann,” user U2 is labeled “Bob,” user U3 is labeled “Carl,” user U4 is labeled “Dee,” user U5 is labeled “Ed,” and user U6 is labeled “Fred.” As shown, system 102 displays the labels next to the respective faces, which facilitates the participants in recognizing each other. For example, in this example, it is possible that user U5 and user U6 joined the video conference with user U4. Users U1, U2, and U3 might know user U4 but not users U5 and U6. Nonetheless, everyone would see the names of each participant, which facilitates communication in the video conference.

Although the steps, operations, or computations may be presented in a specific order, the order may be changed in particular embodiments. Other orderings of the steps are possible, depending on the particular implementation. In some particular embodiments, multiple steps shown as sequential in this specification may be performed at the same time.

While system 102 is described as performing the steps as described in the embodiments herein, any suitable component or combination of components of system 102 or any suitable processor or processors associated with system 102 may perform the steps described.

Embodiments described herein provide various benefits. For example, embodiments facilitate video conferences by enabling participants in a video conference to identify each other. Embodiments described herein also increase overall engagement among end-users in a social networking environment.

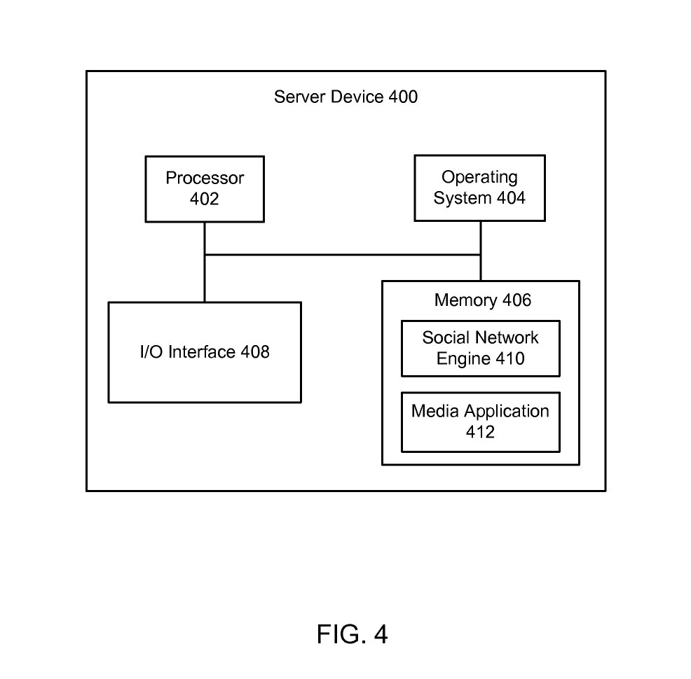

FIG. 4 illustrates a block diagram of an example server device 400, which may be used to implement the embodiments described herein. For example, server device 400 may be used to implement server device 104 of FIG. 1, as well as to perform the method embodiments described herein. In one embodiment, server device 400 includes a processor 402, an operating system 404, a memory 406, and an input/output (I/O) interface 408. Server device 400 also includes a social network engine 410 and a media application 412, which may be stored in memory 406 or on any other suitable storage location or computer-readable medium. Media application 412 provides instructions that enable processor 402 to perform the functions described herein and other functions.

For ease of illustration, FIG. 4 shows one block for each of processor 402, operating system 404, memory 406, I/O interface 408, social network engine 410, and media application 412. These blocks 402, 404, 406, 408, 410, and 412 may represent multiple processors, operating systems, memories, I/O interfaces, social network engines, and media applications. In other embodiments, server device 400 may not have all of the components shown and/or may have other elements including other types of elements instead of, or in addition to, those shown herein.

Although the description has been described with respect to particular embodiments thereof, these particular embodiments are merely illustrative, and not restrictive. Concepts illustrated in the examples may be applied to other examples and embodiments.

Note that the functional blocks, methods, devices, and systems described in the present disclosure may be integrated or divided into different combinations of systems, devices, and functional blocks as would be known to those skilled in the art.

Any suitable programming languages and programming techniques may be used to implement the routines of particular embodiments. Different programming techniques may be employed such as procedural or object-oriented. The routines may execute on a single processing device or multiple processors. Although the steps, operations, or computations may be presented in a specific order, the order may be changed in different particular embodiments. In some particular embodiments, multiple steps shown as sequential in this specification may be performed at the same time.

A “processor” includes any suitable hardware and/or software system, mechanism or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

1. A method comprising:
detecting one or more faces of participants in a video during a video conference;
recognizing one or more of the faces, wherein the recognizing includes matching each face to samples of faces that have been labeled prior to the video conference;
enabling each participant to sign in to the video conference in a video conference joining process as each participant joins the video conference;
determining a name of each participant, where the name of each participant is determined from the video conference joining process;
comparing the name of each participant who joins the video conference with names listed in a stored list of participants scheduled to attend the video conference;
verifying the identity of each participant who joins the video conference; and
labeling the one or more faces in the video.

2. A method comprising:
detecting one or more faces of participants in a video during a video conference;
recognizing one or more of the faces;
enabling each participant to sign in to the video conference in a video conference joining process as each participant joins the video conference;
determining a name of each participant, where the name of each participant is determined from the video conference joining process;
comparing the name of each participant who joins the video conference with names listed in a stored list of participants scheduled to attend the video conference;
verifying the identity of each participant who joins the video conference; and
labeling the one or more faces in the video.

3. The method of claim 2, further comprising accumulating various samples of a same face for a given participant, wherein different samples have different characteristics, and wherein the samples include one or more of the given participant with and without wearing eye glasses, the given participant having different hair lengths, and the given participant with and without wearing a hat.

4. The method of claim 2, wherein the recognizing includes matching each face to samples of faces that have been labeled prior to the video conference.

5. The method of claim 2, wherein the recognizing includes matching each face to samples of faces that have been labeled during one or more previous video conferences.

6. The method of claim 2, wherein the recognizing includes:
determining if each face corresponds to a video stream from a single participant; and
in response to each positive determination, determining the name of each participant, wherein the name of each participant is determined from the video conference joining process.

7. The method of claim 2, further comprising training a classifier to recognize faces, wherein the training of the classifier includes collecting samples of faces that have been labeled prior to the video conference.

8. (canceled)

9. The method of claim 2, further comprising training a classifier to recognize faces, wherein the training of the classifier includes collecting samples of faces that have been labeled during one or more previous video conferences.

10. The method of claim 2, further comprising training a classifier to recognize faces, wherein the training of the classifier includes collecting samples of faces that have been labeled prior to the video conference, wherein at least a portion of the collected samples includes a plurality of samples of faces associated with one participant, and wherein the plurality of samples of faces includes variations of a same face.

11. The method of claim 2, further comprising determining names of some participants in the video using a calendaring system, wherein the calendaring system stores names of participants when video conferences are scheduled.

12. A system comprising:
one or more processors; and
logic encoded in one or more tangible media for execution by the one or more processors and when executed operable to perform operations comprising:
detecting one or more faces of participants in a video during a video conference;
recognizing one or more of the faces;
enabling each participant to sign in to the video conference in a video conference joining process as each participant joins the video conference;
determining a name of each participant, where the name of each participant is determined from the video conference joining process;
comparing the name of each participant who joins the video conference with names listed in a stored list of participants scheduled to attend the video conference;
verifying the identity of each participant who joins the video conference; and
labeling the one or more faces in the video.

13. The system of claim 12, wherein, to recognize the one or more faces, the logic when executed is further operable to perform operations comprising matching each face to samples of faces that have been labeled prior to the video conference.

14. (canceled)

15. The system of claim 12, wherein, to recognize the one or more faces, the logic when executed is further operable to perform operations comprising matching each face to samples of faces that have been labeled during one or more previous video conferences.

16. The system of claim 12, wherein, to recognize the one or more faces, the logic when executed is further operable to perform operations comprising:
determining if each face corresponds to a video stream from a single participant; and
in response to each positive determination, determining the name of each participant, wherein the name of each participant is determined from the video conference joining process.

17. The system of claim 12, wherein the logic when executed is further operable to perform operations comprising training a classifier to recognize faces, and wherein the training of the classifier includes collecting samples of faces that have been labeled prior to the video conference.

18. (canceled)

19. The system of claim 12, wherein the logic when executed is further operable to perform operations comprising training a classifier to recognize faces, wherein the training of the classifier includes collecting samples of faces that have been labeled during one or more previous video conferences.

20. The system of claim 12, wherein the logic when executed is further operable to perform operations comprising training a classifier to recognize faces, wherein the training of the classifier includes collecting samples of faces that have been labeled prior to the video conference, wherein at least a portion of the collected samples includes a plurality of samples of faces associated with one participant, and wherein the plurality of samples of faces includes variations of a same face.
